(19) United States
(12) Patent Application Publication
(10) Pub. No.: US 2005/0189914 A1
(43) Pub. Date: Sep. 1, 2005

(54) Universal cellular telephone battery charger

(76) Inventor: Sam Esses, Brooklyn, NY (US)

Correspondence Address: LAW OFFICE OF MORRIS E. COHEN, 1122 CONEY ISLAND AVENUE, SUITE 217, BROOKLYN, NY, 11230, US

(21) Appl. No.: 11/005,497

(22) Filed: Dec. 6, 2004

Related U.S. Application Data
(60) Provisional application No. 60/527,567, filed on Dec. 5, 2003.

(51) Int. Cl. H02J 7/00

(52) U.S. Cl. 320/116

(57) ABSTRACT

A kit for charging any one of a plurality of cellular telephones having different power input connectors, the kit including a battery charger for a cellular telephone, the battery charger including a component for accepting power from a power source and being connected to a first adapter. The kit further includes a set of second adapters, each of the second adapters including a mating end configured such that a user can attach any of the second adapters to the first adapter. The set of second adapters includes at least two second adapters, the second adapters each having an end configured for attachment to cellular telephones having different power input connectors, such that a user can select a suitable second adapter from the set of second adapters, attach the second adapter to the mating end of first adapter, attach the second adapter to the power input connector of the user's cellular telephone, and plug the component into a power source, to conduct power from the component to the first adapter to the second adapter to the cellular telephone to charge the cellular telephone.

### RELATED APPLICATIONS

The present application claims the priority of U.S. Provisional Application Ser. No. 60/527,567 filed Dec. 5, 2003, the disclosure of which is fully incorporated herein by reference.

### FIELD OF THE INVENTION

The present invention relates to battery chargers for cellular telephones.

### BACKGROUND OF THE INVENTION

Within the past decade, cellular telephones have become increasingly popular devices for enabling mobile telecommunications without the need to rely on pay telephones or find a telephone in the nearby vicinity. Since cellular telephones are intended to be fully portable, it is necessary to charge the telephone's battery on a regular basis to provide the telephone with power for the frequent instances when a power outlet is not nearby or regularly accessible.

Over the years, cellular telephone technology has become increasingly advanced, with new models (including smaller telephones and telephones with more features) coming out regularly. Since each telephone requires a charger which connects to that telephone's particular power input, when the user purchases a new telephone from a manufacturer different from the manufacturer of his or her old phone, he or she must likewise purchase a new telephone charger as well, since the old charger is usually not compatible. Likewise, even with phones from the same manufacturer, the chargers from the user's old models may not be compatible with the new model being purchased.

### SUMMARY OF THE INVENTION

The present invention is directed to a cellular telephone battery charger which can be used with the cellular telephones of different manufacturers. Preferably, the cellular telephone battery charger can be used with a plurality of different telephone models (from the same manufacturer or different manufacturers) that would ordinarily require different telephone chargers. Rather than obtain a separate battery charger for each new cell phone or model that a user obtains over the course of time, the invention allows the use of a single charger that can be adapted with multiple cell phone models. As such, the invention functions as a universal charger for cellular telephones.

Further objects of the invention will become apparent in conjunction with the detailed description and figures provided herewith.

### BRIEF DESCRIPTION OF THE FIGURES

FIG. 1 is a schematic view illustrating a preferred embodiment of the present invention.

### DETAILED DESCRIPTION OF THE INVENTION AND THE PREFERRED EMBODIMENTS

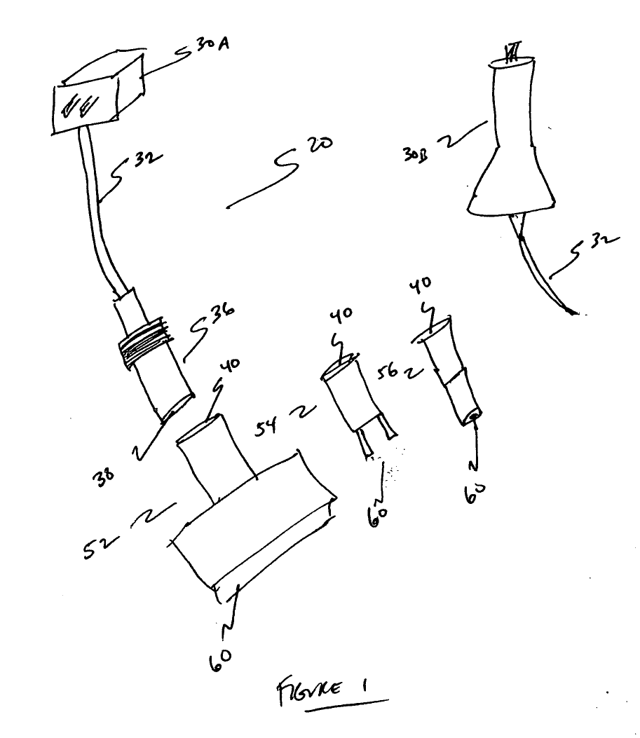

In accordance with the present invention, a universal cellular telephone battery charger 20 is provided as shown in FIG. 1. Battery charger 20 can be a charger for use in the home, for travel, for use in the car, or in any other desired context. In the preferred embodiment, battery charger 20 is a highly portable device. In a further preferred embodiment, battery charger 20 is provided for use during travel.

Battery charger 20 includes a component 30 for plugging the charger into a power source, and cord 32 for carrying power to the telephone, as are well known in the art. Component 30 may be any suitable module for plugging the charger into a power outlet, whether a module for plugging into a wall outlet (component 30a), or for plugging into a car's cigarette lighter (component 30b), or so forth. Component 30a can include standard prongs for insertion into the wall outlet, or can be provided with prongs which are folded down when not in use, as is common on some current charger models.

Component 30 includes circuitry for conducting power from the power source to the variety of cellular telephone models that well known in the art. For example, if used with an AC power source, component 30 includes a transformer for converting the alternating current (AC) input from the power source into direct current (DC) output for the phone. In a preferred embodiment, a component is used which can accept a variety of AC inputs and which provides a power output which is compatible with a range of cellular telephones, particularly those most popular in the marketplace. For example, in one preferred embodiment, the component 30 can provide an AC input of 90 to 250 volts (allowing use of the charger both in the United States or abroad), and can provide an output of 5 to 11 volts of direct current (DC) for use with various different cellular telephones.

In accordance with the invention, universal battery charger 20 (not to scale in the drawing) also includes a power cord 32 which extends from component 30, with electric current being conducted over the power cord through two adapters and to the telephone of interest. Power cord 32 extends from component 30 at one end to a first adapter 36 at the second end of the cord.

First adapter 36 is an adapter at the end of the power cord which serves as an intermediary that attaches and conducts power to the actual adapter used to charge the telephone. First adapter 36 is, therefore, a universal adapter which can attach to any of a plurality of second, customized adapters. The second, customized adapters are specifically configured for attachment to the power input of various cellular telephones of interest.

Thus, in the preferred embodiment, first adapter 36 is an intermediary unit which conducts power to a complementary second adapter 52, 54 56 (the “customized adapter”), the customized adapter being configured for attachment to a particular model cell phone to provide power to that phone. As shown in FIG. 1, in the preferred embodiment, first adapter 36 includes a mating end 38, with mating end 38 being configured to attach to (i.e. mate with) a corresponding mating end 40 provided on the customized adapter, to conduct power from the first adapter 36 to the customized adapter and to the cellular telephone. Mating end 40 is preferably the same on all of the customized adapters, so that any of the customized adapters can be used to mate with the first adapter.

Each customized adapter, e.g. customized adapters 52, 54, or 56, etc. (enlarged in the figure for illustration purposes) is therefore provided with an end 40 which attaches to the first adapter 36 of the universal charger. The customized adapter is provided on its other side with a terminal end 60 which is customized for attachment to the desired phone of interest. Terminal end 60 plugs into the power input connector of the particular telephone of the user.

Thus, one customized adapter may have a terminal end 60 suitable for attachment to the power input connector of Motorola phones (e.g. models 2297, V2297, T193, C332), one may have a terminal end suitable for attachment to Ericsson phones (e.g. models T28, T29, T38, T300), one may have a terminal end suitable for attachment to Samsung phones (e.g. models A300, R225, V205), one may have a terminal end suitable for attachment to other Motorola or Nextel phones (e.g. models i50, i85, i90, i95, V60, V66, T720), one may have a terminal end suitable for attachment to Nokia phones (e.g. models 8200, 3300, 5100, 6100), and so forth for any other current phones or future phones provided in the art.

In the preferred embodiment, universal battery charger 20 includes only one power cord between the power source and the telephone, namely, a first power cord 32 from the component 30 to the first adapter, with no additional power cords between the component 30 and the mating end of the first adapter, or between the two ends of the second adapter. In this manner, power is conducted through the component 30, through first power cord 32, through the first adapter and second adapter and into the cellular telephone.

Preferably, the invention is provided as part of a kit, with a plurality of customized adapters being provided in the kit, so that the user can select the customized adapter suitable for his or her telephone. The customized adapters in the kit are designed for attachment to the power input connector of various cellular telephones of interest. When the user switches phones, he or she can switch to another customized adapter in the kit, or obtain a suitable customized adapter for the new phone.

In a preferred embodiment of the invention, the battery charger is small and lightweight for use during travel. For example, the entire assembly (including the component 30, first adapter and second adapter) can be provided to weight two ounces or less, or be of a similar low weight (e.g. three to five ounces or less).

In the preferred embodiment, the second adapter is a single module with a mating end to connect to the first adapter on one side, and a connector which attaches to the cellular telephone on the other side of the module. Alternatively, the second adapter can itself have a power cord separating the mating end which attaches to the first adapter and the terminal end which attaches to the cellular telephone.

In this manner, the user can purchase one universal adapter regardless of the number of phones her or she currently has or may obtain in the future. The user can then obtain a relatively inexpensive customized adapter with an terminal end 60 configured for his or her particular phone, allowing use of the universal charger 20 with the particular telephone of interest. Likewise, each time a user purchases a new telephone he or she need not buy a new telephone charger for use with that phone. Rather, the user can merely use the appropriate adapter from the kit, or purchase a customized adapter suitable for use with the new phone.

Similarly, retailers need not carry large numbers of different types of chargers, each for a different phone, but can stock one kit and/or one type of adapter, with a selection of multiple types of adapters for each of the phones of interest. When a new phone comes out, the retailer can keep existing universal chargers. If the necessary adapter is in the kit, the universal charger is ready for use with the new phone; alternatively, the retailer can merely obtain a new set of adapters for providing the appropriate adapter to his or her customers for use with the new phone and the universal charger. Similarly, when an old phone is discontinued, there is no need to worry about discarding any stock of chargers for that phone, since the universal charger of the present invention can be used with later models.

Further preferably, the same second adapter can be used with a universal charger for the home or for travel as with a charger for the car, allowing the user to interchange that adapter if desired between his or her home charger, car charger, and so forth. Moreover, the user does not need to carry around multiple chargers when traveling if the user (or his family) owns multiple phones, the phones being of different manufacturers or types.

In an alternate embodiment of the invention, multiple customized adapters can all extend from cord 32, each such customized adapter being configured for attachment to a particular type of phone. However, the embodiment shown in FIG. 1 is preferred.

In accordance with the invention, any other desired features and/or circuitry for battery chargers and/or for the adapters that are currently known or later developed in the art may be included with the charger as well.

Having described this invention with regard to specific embodiments, it is to be understood that the description is not meant as a limitation since further embodiments, modifications and variations may be apparent or may suggest themselves to those skilled in the art. It is intended that the present application cover all such embodiments, modifications and variations.

1. An apparatus, comprising:
a kit for charging any one of a plurality of cellular telephones having different power input connectors;
said kit comprising a battery charger for a cellular telephone, said battery charger comprising a component for accepting power from a power source;
said component being connected to a first adapter;
said kit further comprising a set of second adapters;
said first adapter comprising a mating end, said second adapters each comprising a mating end for attachment to said first adapter, said mating end of said second adapters being configured such that a user can attach any of said second adapters to said first adapter;
said second adapters further comprising an end for attachment of said second adapter to the power input connector of a cellular telephone;
said set of second adapters comprising at least two second adapters, said at least two second adapters being configured for attachment to cellular telephones having different power input connectors;
such that a user can select a suitable second adapter from said set of second adapters, attach said second adapter to said mating end of first adapter, attach said second adapter to the power input connector of the user's cellular telephone, and plug said component into a power source, to conduct power from said component to said first adapter to said second adapter to the cellular telephone to charge the cellular telephone.

2. An apparatus as claimed in claim 1, wherein a single power cord extends between said component and said cellular telephone when said first adapter is attached to said second adapter and said second adapter is attached to said cellular telephone.

3. An apparatus as claimed in claim 1, wherein said component is portable for use as a travel charger.

4. An apparatus as claimed in claim 1, wherein said component is configured for accepting power from an AC power source.

5. An apparatus as claimed in claim 1, wherein said component is configured for accepting power from a DC power source.

6. An apparatus as claimed in claim 1, wherein, after attachment, said second adapter is detachable from said first adapter by the user.
